(19) United States
(12) Patent Application Publication
(10) Pub. No.: US 2026/0149887 A1
(43) Pub. Date: May 28, 2026

(54) IMAGE PROCESSING APPARATUS AND IMAGE PROCESSING METHOD

(71) Applicant: CANON KABUSHIKI KAISHA, Tokyo (JP)

(72) Inventor: MISAKI SUZUKI, Kanagawa (JP)

(21) Appl. No.: 19/387,891

(22) Filed: Nov. 13, 2025

(30) Foreign Application Priority Data
Nov. 28, 2024 (JP) 2024-207703

(51) Int. Cl. H04N 23/73; H04N 23/71

(52) U.S. Cl. CPC H04N 23/73; H04N 23/71

(57) ABSTRACT

An image processing apparatus includes a first obtaining unit that obtains an image, a first detection unit that detects a first region including a subject in the image, a second detection unit that detects a second region in the image, a second obtaining unit that obtains, in a case where a state of the subject is a predetermined state, a photometric result based on luminance of a region where the first region and the second region overlap each other, a first determination unit that determines a change in the second region based on a reference region of the second region, and a decision unit that decides exposure based on a determination result of the first determination unit and the photometric result obtained by the second obtaining unit.

### BACKGROUND

### Field of the Technology

The present disclosure relates to image processing of stabilizing exposure.

### Description of the Related Art

An image capture apparatus such as a digital camera performs exposure control by obtaining a photometric value from the luminance of a subject region included in an image and obtaining, from the photometric value, an exposure correction value to cause the luminance to converge to proper luminance, thereby making it possible to properly keep the brightness of an image of a scene to be shot. There is also known a method of detecting a region such as the face or head of a person and calculating such exposure correction value that the detected region has proper luminance. However, in a case where the detected region includes a background and hair, the region may deviate from the proper luminance due to the influence of these.

Japanese Patent Laid-Open No. 2005-148915 describes a method of detecting a pixel representing a skin color included in a subject region and calculating, based on the luminance value of the detected pixel, an exposure correction value for obtaining appropriate luminance in a face region.

However, even if skin color detection is performed as described in Japanese Patent Laid-Open No. 2005-148915, in a case where a luminance difference (fluctuation) occurs in a skin region, exposure may become unstable.

### SUMMARY

The present disclosure has been made in consideration of the aforementioned problems, and provides technical advantages that even in a case where a fluctuation occurs in a subject detection region, exposure is stabilized.

According to one aspect of the embodiments, there is provided an image processing apparatus comprising: at least one processor; and at least one memory coupled to the at least one processor storing instructions that, when executed by the at least one processor, cause the at least one processor to function as: a first obtaining unit that obtains an image; a first detection unit that detects a first region including a subject in the image; a second detection unit that detects a second region in the image; a second obtaining unit that obtains, in a case where a state of the subject is a predetermined state, a photometric result based on luminance of a region where the first region and the second region overlap each other; a first determination unit that determines a change in the second region based on a reference region of the second region; and a decision unit that decides exposure based on a determination result of the first determination unit and the photometric result obtained by the second obtaining unit.

Features of the present disclosure will become apparent from the following description of embodiments with reference to the attached drawings. The following description of embodiments is given by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram exemplifying an apparatus configuration according to a present embodiment;

FIG. 2 is a flowchart exemplifying control processing according to the present embodiment;

FIGS. 3A to 3G are views illustrating the luminance value of an image according to the present embodiment;

FIG. 4 is a flowchart exemplifying fluctuation determination processing of a skin region according to the present embodiment;

FIGS. 5A to 5E are views illustrating a method of deciding a reference skin region according to the present embodiment;

FIGS. 6A and 6B are views illustrating the degree of matching between the reference skin region and the skin region according to the present embodiment;

FIGS. 7A to 7E are views illustrating a method of determining the angle of a face according to the present embodiment;

FIGS. 8A to 8E are views illustrating a method of determining shading of a face according to the present embodiment;

FIGS. 9A, 9B, 9C1 to 9C3, and 9D1 to 9D3 are views illustrating a background according to the present embodiment;

FIG. 10 is a flowchart exemplifying first processing of deciding the reference skin region according to the present embodiment; and

FIG. 11 is a flowchart exemplifying second processing of deciding the reference skin region according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### BACKGROUND

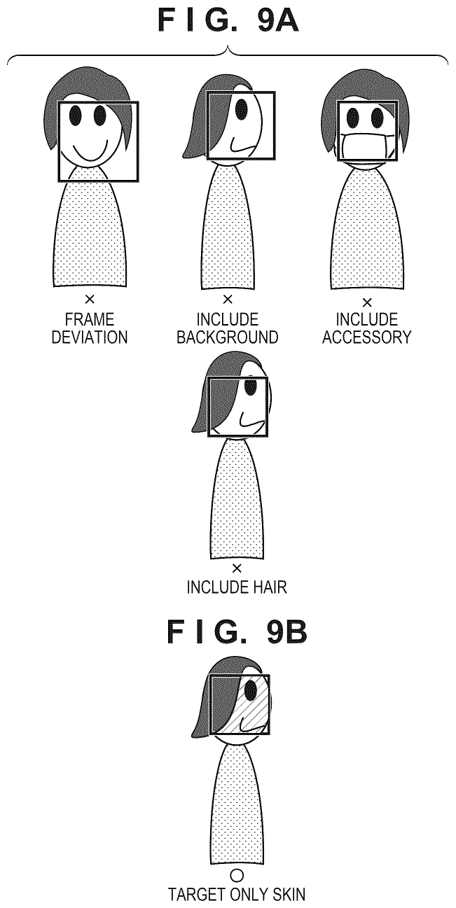

First, the background of the present embodiment will be described with reference to FIGS. 9A, 9B, 9C1, 9C2, 9C3, 9D1, 9D2, and 9D3.

FIGS. 9A, 9B, 9C1, 9C2, 9C3, 9D1, 9D2, and 9D3 are views illustrating a problem of the present embodiment.

In a case where an exposure correction value suitable for a subject is calculated based on a subject detection processing result, a background and hair may be included in a detection frame due to variations in the position and size of the detection frame, as shown in FIG. 9A. In particular, if the detection frame shifts in a status in which luminance deviates such as a status in which a face is dark and a background is bright in a backlight scene or the like, luminance values are averaged in a state in which the luminance of the dark face to be extracted and the luminance of the bright background are mixed, and thus a luminance value higher than an expected value is calculated. If an exposure correction value is calculated based on such high luminance value, exposure varies and the face may not have proper luminance. Similarly, in a case where the detection frame overlaps an accessory such as a mask or sunglasses, exposure may vary.

To the contrary, as shown in FIG. 9B, in a case where an exposure correction value is calculated only for a skin region obtained by skin detection, it is possible to avoid exposure from varying due to the luminance of the background or an accessory, but a skin region cannot always be detected correctly by skin detection. For skin detection, it is possible to use a known method such as a method of extracting a color gamut of a predetermined range defined as a skin color or a method by an algorithm that learns a skin region by machine learning but there exists a scene where detection is difficult.

FIG. 9C1 exemplifies a state in which the face region of a subject has approximately the same luminance, the subject stays still, and a scene remains unchanged. In this case, the left half of the face may be detected as a skin region, as shown in FIG. 9C2, the right half of the face may be detected as a skin region, as shown in FIG. 9C3, and a luminance difference may occur between the left and right skin regions. If the luminance values of the left and right skin regions are approximately equal to each other, an exposure correction value becomes stable, and thus exposure does not largely vary. However, for example, if the face region has shading, the luminance value of the skin region changes, and thus the exposure correction value is unstable, thereby causing exposure to largely vary.

In the present embodiment, the occurrence of a luminance difference in a skin region is called a fluctuation in a skin region. A fluctuation in a skin region indicates that the luminance value of the skin region largely changes although a scene remains unchanged.

FIG. 9D1 exemplifies a state in which the face region of a subject has shading, the subject stays still, and a scene remains unchanged. In this case, the bright region may undergo skin detection, as shown in FIG. 9D2, and the dark region may undergo skin detection at a different timing, as shown in FIG. 9D3. If a luminance value is calculated from each of the bright and dark skin regions while a fluctuation occurs in the skin region, an exposure correction value may become unstable, and exposure may largely vary.

To cope with this, in the present embodiment, even in a case where a fluctuation occurs in a skin region, exposure can be stabilized.

### <Apparatus Configuration>

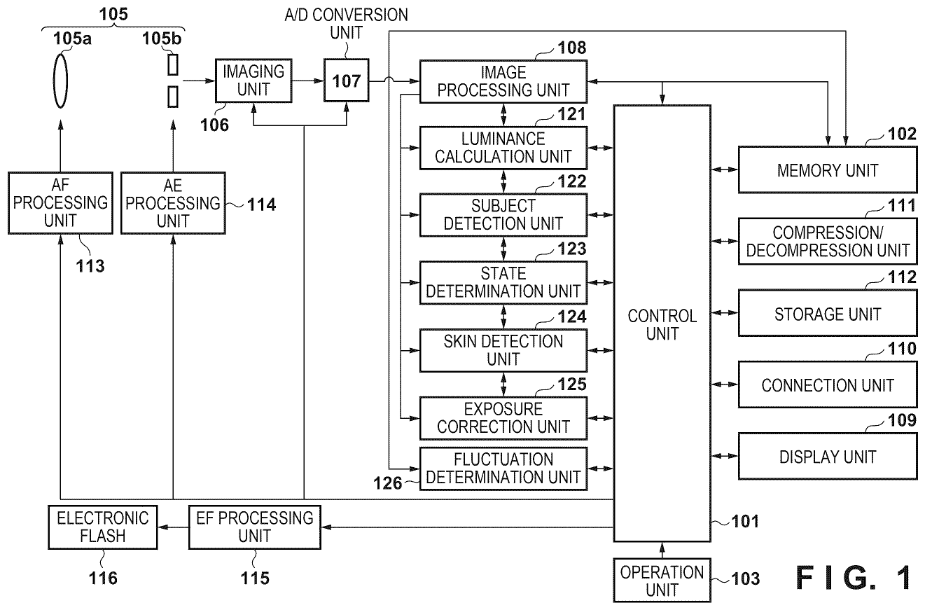

The configuration and function of a digital camera (to be referred to as a camera hereinafter) according to the present embodiment will be described next with reference to FIG. 1.

FIG. 1 is a block diagram showing the configuration of a camera 100 according to the present embodiment.

In FIG. 1, a component represented as a block can be implemented by an integrated circuit (IC) such as an ASIC or FPGA, a discrete circuit, or a combination of a memory and a processor for executing a program stored in the memory. One block may be implemented by a plurality of integrated circuit packages or a plurality of blocks may be implemented by one integrated circuit package. In addition, the same block may be implemented by a different component in accordance with the operating environment, required ability, and the like.

The present embodiment will describe an example of applying an image processing apparatus of the present disclosure to an image capture apparatus such as a digital camera. However, the present disclosure is not limited to this, and the image processing apparatus is widely applicable to an electronic apparatus having a shooting function. The electronic apparatus includes a computer apparatus (personal computer, tablet computer, media player, PDA, and the like), a portable phone, a smartphone, a game machine, a robot, a drone, a drive recorder, and a medical apparatus.

A control unit 101 is, for example, an arithmetic processing unit such as a CPU or an MPU that controls the overall camera 100. The control unit 101 implements processing of a flowchart to be described later by executing a program read out from a storage unit 112 and loaded into a memory unit 102.

The memory unit 102 includes a volatile memory such as a RAM, and is used as a work memory to which constants, variables, programs, and the like for the operation of the control unit 101 are deployed.

The memory unit 102 temporarily stores data during processing of each of an image processing unit 108, a compression/decompression unit 111, a subject detection unit 122, a state determination unit 123, a skin detection unit 124, an exposure correction unit 125, and a fluctuation determination unit 126, or data after completion of the processing.

An operation unit 103 includes switches, buttons, and dials each for accepting a user operation such as an operation of turning on/off the power, a shooting preparation instruction operation, a shooting instruction operation, a menu screen display operation, or an operation mode change operation. Furthermore, the operation unit 103 includes a touch sensor 104 that can detect a touch operation on a display unit 109 to be described later. The operation mode of the camera 100 can be switched to one of, for example, a still image shooting mode, a moving image recording mode, and a reproduction mode.

An imaging unit 106 includes an image sensor formed by a photoelectric conversion element such as a CCD or CMOS sensor that converts, into an electrical signal, an optical image of a subject formed by an optical system 105 that includes a lens 105a including a zoom lens and a focus lens, a stop/shutter 105b, and mechanisms for driving these optical members. The imaging unit 106 outputs, to an A/D conversion unit 107, an analog image signal generated by capturing an optical image of a subject.

The A/D conversion unit 107 performs sampling, gain adjustment, and the like for the analog image signal output from the imaging unit 106, and converts the thus obtained signal into a digital signal.

The image processing unit 108 performs resize processing such as predetermined pixel interpolation and reduction, color conversion processing, and gamma conversion processing for the data output from the A/D conversion unit 107. The control unit 101 performs predetermined arithmetic processing for performing Auto Focus (AF) processing, Auto Exposure (AE) processing, and flash pre-emission (EF) processing using the image data processed by the image processing unit 108.

The display unit 109 includes a Liquid Crystal Display (LCD) or an organic Electro Luminescence (EL) display, and displays the shooting state, shot images, various settings, operation mode, and the like of the camera 100. The display unit 109 is provided with a touch sensor. The touch sensor can detect a contact (touch operation) on the display surface of the display unit 109 (the touch operation surface of the touch sensor).

A connection unit 110 is an interface connector that connects an external apparatus such as an external monitor or an external storage to the camera main body and transmits/receives images and sounds. By connecting the camera main body to the external monitor by the connection unit 110, it is possible to display the screen of the display unit 109 on the external monitor. By connecting the camera main body to the external storage by the connection unit 110, it is possible to store image data shot by the camera in the external storage. The connection unit 110 is, for example, an analog output terminal such as a composite terminal, an S video terminal, a D terminal, a component terminal, or analog RGB terminals, or a digital output terminal such as a DVI terminal or an HDMI® terminal.

The compression/decompression unit 111 performs processing of compression-coding, in a predetermined format (JPEG or the like), image data output from the image processing unit 108 and stored in the memory unit 102 and storing the thus obtained data in the storage unit 112, and processing of reading out a coded image file from the storage unit 112 and decoding an image signal.

The storage unit 112 is a nonvolatile memory such as a ROM, a memory card, a hard disk, or the like. The storage unit 112 stores image files, and constants, programs, and the like for the operation of the control unit 101.

An AF processing unit 113 performs AF processing of focusing on the image data by displacing the position of the focus lens of the optical system 105 based on an arithmetic processing result (a phase difference and contrast) concerning AF processing performed by the control unit 101 using the image data processed by the image processing unit 108.

An AE processing unit 114 performs AE processing of optimizing exposure by changing the diaphragm aperture and the shutter speed of the optical system 105 based on an exposure correction value calculated by the exposure correction unit 125 (to be described later) based on a photometric result calculated by a luminance calculation unit 121. Note that in the present embodiment, the stop/shutter 105b adjusts the exposure time of the imaging unit 106. However, the present disclosure is not limited to this, and for example, it may be configured to control a gain used for gain adjustment performed by the A/D conversion unit 107, or it may be configured so that the imaging unit 106 has an electronic shutter function and adjusts the exposure time by a control signal. Furthermore, it may be configured to control an EF processing unit 115 to cause an electronic flash 116 to emit light in accordance with a photometric result. In this case, the control unit 101 may determine and instruct light emission of the electronic flash 116 in cooperation with the AE processing unit 114.

The EF processing unit 115 performs EF processing of irradiating a subject with auxiliary light by causing the electronic flash 116 to emit light in a case where brightness at the time of shooting is not proper based on an arithmetic processing result concerning EF processing performed by the control unit 101 using the image data processed by the image processing unit 108.

The luminance calculation unit 121 calculates a luminance value using the image data generated by the image processing unit 108, and calculates a photometric result as a difference between the calculated luminance value and proper luminance. The luminance calculation unit 121 calculates the photometric result using image data of an overlap region where a subject region (face region or head region) detected by the subject detection unit 122 and a skin region detected by the skin detection unit 124 overlap each other.

The subject detection unit 122 detects a region of a subject included in an image using the image data generated by the image processing unit 108. The present embodiment assumes that the subject is a person, and the subject detection unit 122 detects face and head regions as subject regions in the image. For subject detection, it is possible to use a known method such as a method of extracting a region from the contour shape of a human body by pattern matching, a method of detecting characteristic important organs such as the eyes, nose, and mouth and detecting a head region including these, or a method by an algorithm that learns the face region of a person by machine learning. For example, in the method using machine learning, learning is performed by associating, as a hierarchical structure, the concepts of respective particle sizes from the whole image to the details of a target. When learning persons, learning is performed using images of persons of various races, ages, sexes, face directions, and hair types. In addition, detected regions can be classified by the head, body, limbs, upper half body, lower half body, and whole body in addition to the face.

The state determination unit 123 determines the state of the face region of the subject detected by the subject detection unit 122. The state of the face region includes, for example, the up, down, left, and right directions of the face, the presence/absence of shading on the face, the presence/absence of hair and beard, and the presence/absence of an accessory such as a mask or sunglasses.

The skin detection unit 124 detects a skin region included in an image using the image data generated by the image processing unit 108. For skin detection, it is possible to use a known method such as a method of extracting a color gamut of a predetermined range defined as a skin color or a method by an algorithm that learns a skin region by machine learning. For example, in the method using machine learning, learning is performed by associating, as a hierarchical structure, the concepts of respective particle sizes from the whole image to the details of a target. When learning skin, learning is performed using images of persons of various races, ages, and sexes, and thus it is possible to detect skin even if people have differences in skin tone.

The exposure correction unit 125 calculates an exposure correction value to cause exposure to converge to proper exposure based on the determination result of the state determination unit 123 and the photometric result of the luminance calculation unit 121.

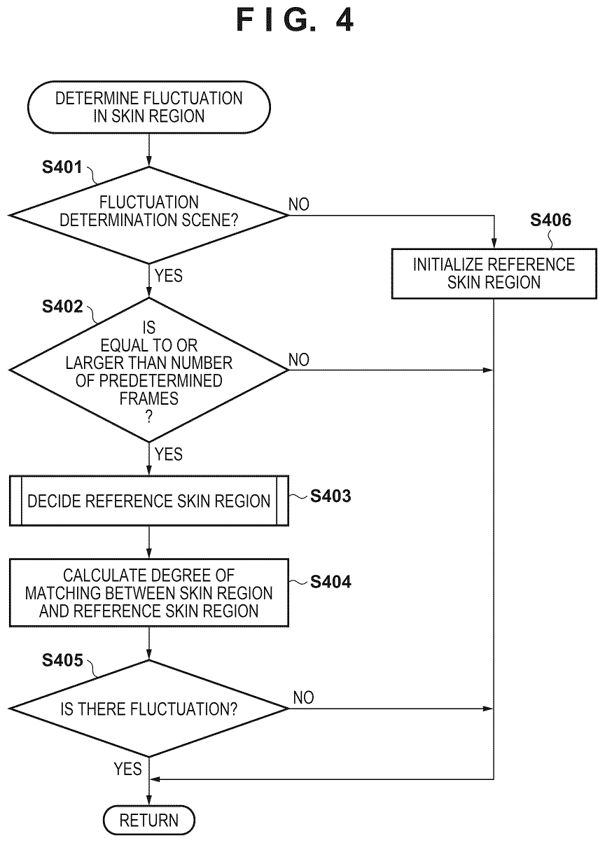

Based on the detection results of the subject detection unit 122 and the skin detection unit 124 and the determination result of the state determination unit 123, which are stored in the memory unit 102, the fluctuation determination unit 126 executes fluctuation determination processing of the skin region to be described later with reference to FIG. 4, thereby determining whether a fluctuation occurs in the skin region.

Note that each of the components 108, 111, 113 to 115, and 121 to 126 shown in FIG. 1 may be implemented by the processor executing software or by dedicated hardware. The functions of at least some of the components 108, 111, 113 to 115, and 121 to 126 shown in FIG. 1 may be included in the control unit 101. In this case, the functions included in the control unit 101 are implemented when, for example, the control unit 101 executes the program stored in the storage unit 112.

### <Control Processing>

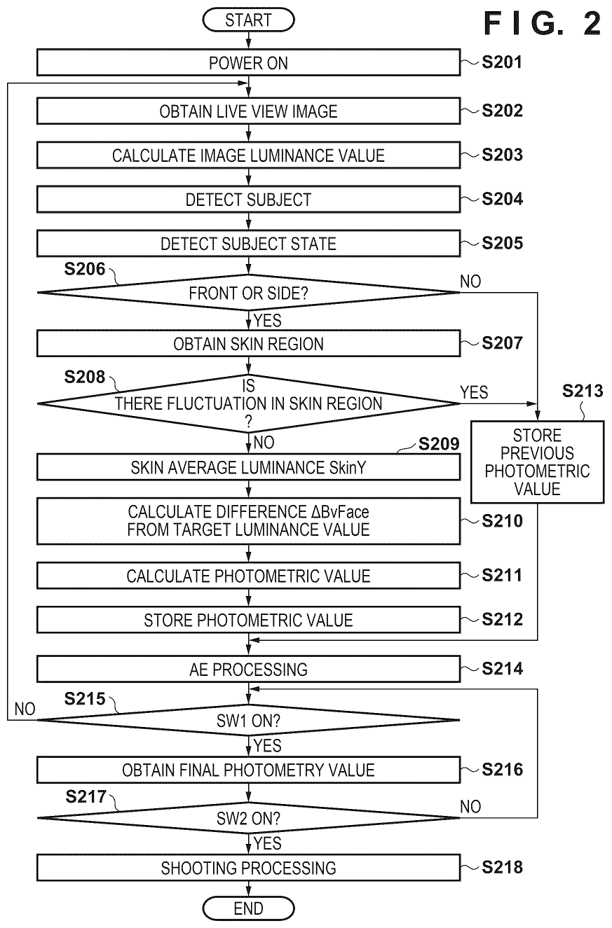

Next, control processing at the time of shooting according to the present embodiment will be described with reference to FIG. 2.

FIG. 2 is a flowchart exemplifying control processing at the time of shooting by the camera 100 according to the present embodiment. Note that the processing shown in FIG. 2 is implemented when the control unit 101 controls the respective components of the camera 100 by deploying the program stored in the storage unit 112 to the memory unit 102 and executing the program.

In step S201, when the user turns on the power included in the operation unit 103 of the camera 100, the operation unit 103 notifies the control unit 101 of the power-on operation and the control unit 101 supplies necessary power to the respective components of the camera 100.

When power is supplied to the respective components of the camera 100, the stop/shutter 105b included in the optical system 105 is driven, and an image of subject image light entering through the lens 105a is formed on the image capture plane of the imaging unit 106. The imaging unit 106 reads out electric charges accumulated in the image sensor, and outputs them as an analog image signal to the A/D conversion unit 107.

The A/D conversion unit 107 performs sampling and gain adjustment for the analog image signal output from the imaging unit 106, and converts the thus obtained signal into a digital image signal, thereby outputting the digital image signal to the image processing unit 108.

The image processing unit 108 generates image data (live view image) by performing various kinds of image processes for the digital image signal output from the A/D conversion unit 107, and stores the image data in the memory unit 102 while outputting the image data to the control unit 101, the luminance calculation unit 121, the subject detection unit 122, the state determination unit 123, the skin detection unit 124, the exposure correction unit 125, and the fluctuation determination unit 126.

In step S202, the control unit 101 obtains the live view image generated by the image processing unit 108.

In step S203, the luminance calculation unit 121 calculates the luminance value (image luminance value) of the entire live view image output from the image processing unit 108. In the present embodiment, first, the entire image is divided into blocks in a lattice pattern, and the luminance values of pixels are averaged for each block, thereby obtaining the luminance value of each block. Then, an average luminance value obtained by multiplying the obtained luminance value of each block by a predetermined weight for each block is set as the image luminance value.

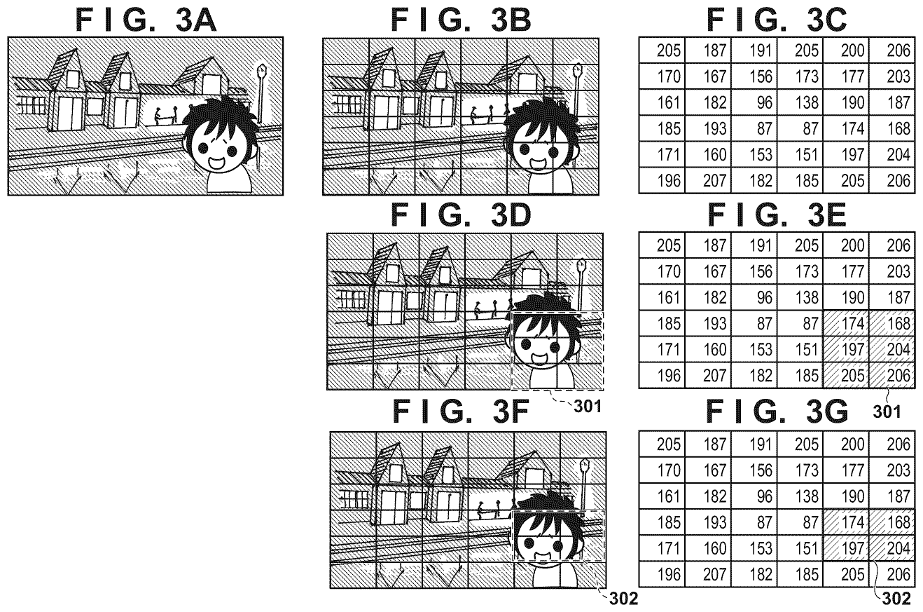

The image luminance value will now be described with reference to FIGS. 3A to 3G.

FIG. 3A exemplifies the live view image output from the image processing unit 108. FIG. 3B shows an example of dividing the live view image shown in FIG. 3A into blocks. FIGS. 3C, 3E, and 3G exemplify the luminance value of each block shown in FIGS. 3B, 3D, and 3F, respectively. The image luminance value is obtained by averaging the luminance values of the respective blocks shown in FIG. 3C. Note that the image luminance value calculated in step S202 is stored in the memory unit 102 so as to be usable in subsequent processing.

In step S204, the subject detection unit 122 detects a subject. In the present embodiment, the subject detection unit 122 detects a person in the live view image, and detects a face or head region or a whole body region of the person as a subject. Note that a subject detection result is stored in the memory unit 102 so as to be usable in subsequent processing.

In step S205, the state determination unit 123 determines the state of the subject. The state of the subject includes the direction of the face, and the presence/absence and type of an accessory such as a mask or sunglasses. In the present embodiment, the state determination unit 123 obtains important organ information of the eyes, nose, and mouth of the face from the face region detected by the subject detection unit 122, and determines the direction of the face based on the positions of the important organs in the face region.

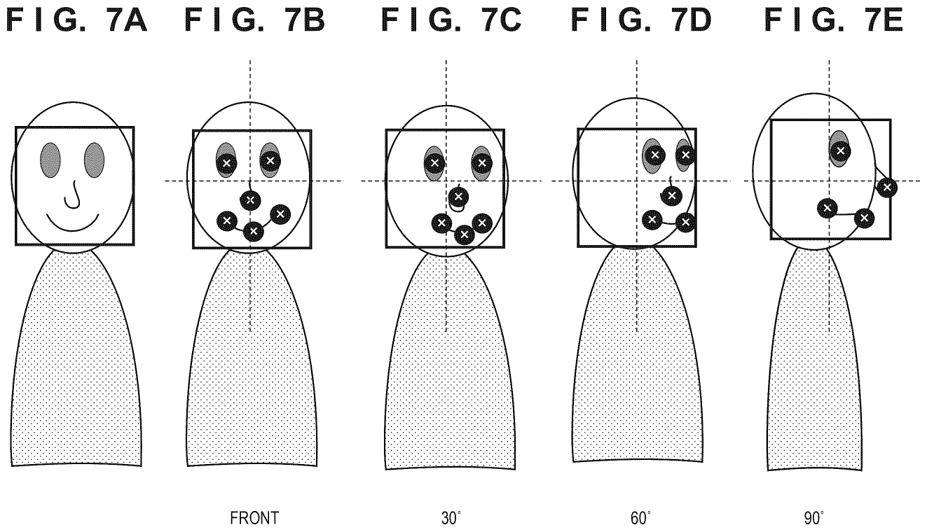

As shown in FIGS. 7A to 7E, the state determination unit 123 sets feature point coordinates for the important organs in the face region.

For example, in a case of a face facing front, as shown in FIG. 7A, the positions of the eyes exist symmetrically with respect to the center line of the detected face region, the nose exists slightly below the center of the screen, and the mouth exists symmetrically with respect to the center line in the lower portion of the screen, as shown in FIG. 7B. In this case, the state determination unit 123 determines that the face faces front (the angle of the face is 0°). In FIG. 7C, the positions of the eyes and nose slightly shift in the left direction as a whole, as compared to FIG. 7B, and thus the state determination unit 123 determines that the angle of the face is 30°. In FIG. 7D, since these positions shift more in the left direction, it is determined that the angle of the face is 60°. In FIG. 7E, since there is one eye, the nose is at the right edge of the frame, and the mouth shifts to the right side of the frame, it is determined that the angle of the face is 90°. Note that the angles shown in FIGS. 7C, 7D, and 7E are merely examples each for indicating how much the face turns sideways. The present disclosure is not limited to them, and any index may be used as long as the state determination unit 123 can grasp, by the index, the magnitude relationship with respect to the direction of the face. Furthermore, the state determination unit 123 determines the presence/absence of shading on the face.

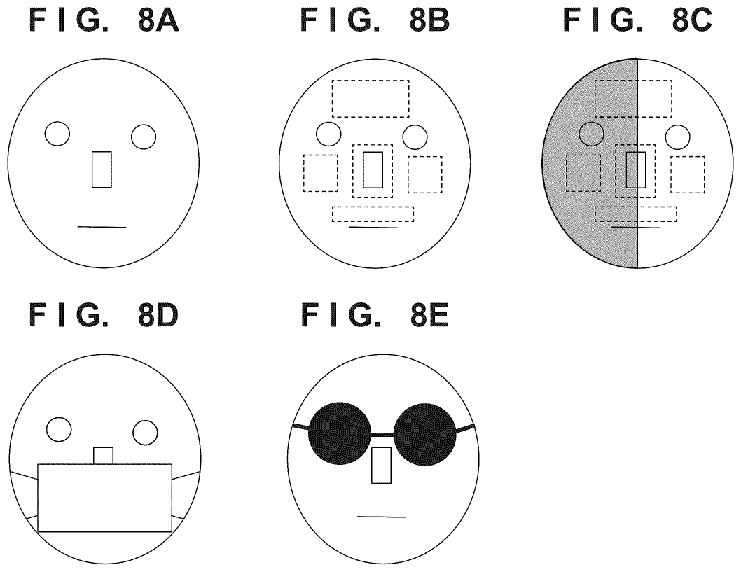

In the present embodiment, first, each of the regions of the entire face, the forehead, the right cheek, the left cheek, the nose, a portion under the nose, and the like is decided based on the important organ information in the face region. For example, in a case of a face facing front, as shown in FIG. 8A, each region obtained from the important organ information can be decided, as indicated by each dotted line portion in FIG. 8B.

Then, the luminance value of each region is obtained by the luminance calculation unit 121, and the presence/absence of shading on the face is determined based on the luminance value of each region. A threshold is preset for a luminance difference between the regions. If the luminance difference is equal to or larger than the threshold, the presence of shading is determined, and if the luminance difference is smaller than the threshold, the absence of shading is determined. In the example shown in FIG. 8B, if there is no luminance difference in the horizontal direction or vertical direction between the regions, it can be determined that the face has no shading. On the other hand, in a case of a face shown in FIG. 8C, a luminance difference is generated in the horizontal direction between the regions (the right cheek and the left cheek), and if the luminance value difference is equal to or larger than the threshold, it can be determined that the face has shading.

Furthermore, the state determination unit 123 determines the presence/absence of the organ information with respect to an accessory such as a mask. As shown in FIG. 8D, if only the eyes are detected as important organs in the face detection frame, and the nose and mouth portions are covered with something other than skin, it is determined that the person wears a mask. As shown in FIG. 8E, if only the mouth and nose are detected as important organs in the face detection frame, and the eye portions are covered with something other than skin, it is determined that the person wears sunglasses or glasses. Note that the state of the subject is stored in the memory unit 102 so as to be usable in subsequent processing.

In step S206, the state determination unit 123 determines, based on the state of the subject detected in step S205, whether the direction of the face is the front direction (front view) or the sideways direction (side view). If a front view or a side view is determined as the direction of the face, the process advances to step S207. If neither a front view nor a side view is determined, the process advances to step S213.

Note that in the present embodiment, as a condition for a side view, a state in which the head turns to the right or the left within a range of about ±90° from the front position of the face is set. The condition for the side view assumes that an area enough to obtain the luminance value of the skin region of the head region can be ensured and variations in exposure are suppressed. If the face faces at an angle exceeding 90° from the front position, it is determined that the area of the skin region is not enough to obtain the luminance value.

In step S207, the skin detection unit 124 detects a skin region existing in the live view image. The present embodiment assumes that the skin detection unit 124 can detect a skin region of a person regardless of the difference in skin color or luminance, and can detect not only a skin region of a face but also skin regions of limbs. Note that a skin region detection result is stored in the memory unit 102 so as to be usable in subsequent processing.

In step S208, the fluctuation determination unit 126 determines a fluctuation in the skin region based on the face region detected in step S204, the state of the subject determined in step S205, and the skin region detected in step S207. Details of the fluctuation determination processing will be described later. If it is determined that a fluctuation occurs in the skin region, the process advances to step S213. If it is determined that no fluctuation occurs in the skin region, the process advances to step S209.

In step S209, the luminance calculation unit 121 calculates skin average luminance SkinY by targeting a region where the face region detected in step S204 and the skin region detected in step S207 overlap each other. A method of calculating the skin average luminance SkinY will now be described with reference to FIGS. 3A to 3G.

In the live view image shown in FIG. 3A, the luminance calculation unit 121 determines, among the divided blocks shown in FIG. 3B, blocks where the face region detected by the subject detection unit 122 exists. In this case, a block region 301 shown in FIGS. 3D and 3E is applicable.

In the live view image shown in FIG. 3A, the luminance calculation unit 121 determines, among the divided blocks shown in FIG. 3B, blocks where the skin region detected by the skin detection unit 124 exists. In this case, a block region 302 shown in FIGS. 3F and 3G is applicable.

Then, the luminance calculation unit 121 obtains the skin average luminance SkinY by averaging the luminance values of the blocks commonly included in the block regions 301 and 302. In the example shown in FIGS. 3A to 3G, 185.75 that is the average value of 174, 168, 197, and 204 is obtained as the skin average luminance Skin Y.

In step S210, the luminance calculation unit 121 calculates a difference ΔBvFace from a target luminance value of a predetermined face based on the skin average luminance SkinY obtained in step S209. The difference ΔBvFace is obtained using a target luminance value ReferenceY, given by:

$$Δ BvFace = {LOG}_{2} ( SkinY / ReferenceY ) \qquad ( 1 )$$

In step S211, the luminance calculation unit 121 calculates a proper photometric value Bv based on the difference ΔBvFace calculated in step S210. The photometric value Bv is calculated by:

$$Bv = CtrlBv + Δ BvFace + BvCorr \qquad ( 2 )$$

where CtrlBv represents an exposure correction value with which the image is obtained, and BvCorr represents various correction values which include correction based on the degree of backlight of the subject, correction based on the ratio of the sky as a high-luminance region, and night scene correction.

In step S212, the control unit 101 stores, in the memory unit 102, the proper photometric value Bv calculated in step S211 so as to be usable in a case where the direction of the face is a direction other than the front direction and the sideways direction. Note that the proper photometric value may be calculated further using the image luminance value obtained in step S203.

If the proper photometric value is obtained further using the image luminance value, the photometric value Bv is calculated by:

$$Bv = ( CtrlBv + Δ BvEa ) \times a + ( CtrlBv + Δ BvFace ) \times b + BvCorr \qquad ( 3 )$$

where ΔBvEa represents a difference from the target luminance value of the photometric value Bv obtained using the image luminance value obtained in step S203. Furthermore, a and b represent coefficients used to decide the use rate of the luminance of the entire image and the luminance of skin region, and a+b=1.0 is satisfied.

By calculating the proper photometric value in consideration of the image luminance value, as described above, it is possible to control exposure so as to obtain proper brightness for not only the face but also the entire image.

In step S206, if a skin region as a surface under the hair is detected in a state in which the direction of the face is a direction other than the front direction and the sideways direction, for example, in a state in which the back of the head is determined, the photometric value is unwantedly calculated for a hair region, and exposure is over in a case of black hair. To avoid this, in step S213, the previous (most recent) photometric value calculated in step S211 performed previously (most recently) is stored in the memory unit 102.

In step S208, even if a fluctuation occurs in the skin region, the photometric value changes along with the change of the above-described skin average luminance SkinY, and exposure becomes unstable. Therefore, in this case as well, in step S213, the previous (most recent) photometric value calculated in step S211 performed previously (most recently) is stored in the memory unit 102.

In step S214, the exposure correction unit 125 calculates an exposure correction value based on the photometric value stored in step S212 or S213, and outputs the calculated exposure correction value to the AE processing unit 114, and the AE processing unit 114 executes the AE processing, thereby controlling to cause exposure to converge to proper exposure.

If the detected subject state is the state of the front view or the side view and the skin region can be detected, the exposure correction unit 125 calculates the exposure correction value using the photometric value of the overlap region of the detected subject region and skin region. On the other hand, if the detected subject state is not the state of the front view or the side view and the skin region with a sufficient size cannot be detected, the exposure correction value is calculated using the previous (most recent) photometric value that has been calculated in step S211 performed previously (most recently) and stored in the memory unit 102 in step S213.

In step S215, the control unit 101 determines whether a shooting preparation instruction (ON of a shutter switch signal SW1) is input from the operation unit 103 when a shutter button included in the operation unit 103 of the camera 100 is pressed halfway. If it is determined that no shooting preparation instruction is input, the process returns to step S202, and the control unit 101 obtains a live view image using the exposure correction value calculated in step S214, and repeats the processes of step S202 to S214 until a shooting preparation instruction (ON of the shutter switch signal SW1) is input with respect to the obtained live view image. If it is determined that the shooting preparation instruction is input, the process advances to step S216.

In step S216, the control unit 101 obtains, as a final photometry value when the shooting preparation instruction is input in step S215, the photometry value obtained in step S211 or S213. Furthermore, the AF processing unit 113 performs the AF processing based on the live view image obtained in step S212, thereby controlling the lens 105a to focus on the subject.

In step S217, the control unit 101 determines whether a shooting instruction (ON of a shutter switch signal SW2) is input from the operation unit 103 when the shutter button included in the operation unit 103 of the camera 100 is pressed fully. If it is determined that no shooting instruction is input, the process returns to step S215. If it is determined that the shooting instruction is input, the process advances to step S218.

In step S218, the control unit 101 performs a series of shooting processes (actual shooting processing) from readout of a signal from the imaging unit 106 to write of a captured image as an image file in the storage unit 112. Furthermore, the control unit 101 detects the current luminance value using the image data output from the image processing unit 108, and if it is determined that the current luminance value is lower than a predetermined threshold, controls the EF processing unit 115 to cause the electronic flash 116 to emit light.

In the actual shooting processing, the imaging unit 106 reads out electric charges accumulated in the image sensor, and outputs them as an analog image signal to the A/D conversion unit 107.

The A/D conversion unit 107 performs sampling and gain adjustment for the analog image signal output from the imaging unit 106, and converts the thus obtained signal into a digital image signal, thereby outputting the digital image signal to the image processing unit 108.

The image processing unit 108 generates image data by performing various kinds of image processes for the digital image signal output from the A/D conversion unit 107, and stores the image data in the memory unit 102.

The compression/decompression unit 111 converts the format of the image data output from the image processing unit 108 into a format such as JPEG, and outputs the thus obtained image data to the storage unit 112.

The storage unit 112 records the format converted image data output from the compression/decompression unit 111 in the internal memory of the camera 100, an external memory inserted to the camera 100, or the like.

As described above, according to the present embodiment, a subject region, subject information, and a skin region are obtained, it is determined whether the skin region can sufficiently be ensured, and exposure is controlled so as to obtain appropriate brightness of the skin region of the face, thereby making it possible to control exposure without influence of the back of the head or an accessory.

Note that in the present embodiment, the direction of the face is used as the state of the subject to determine whether the skin region can sufficiently be ensured, but the present disclosure is not limited to this. By comprehensively using the region of the face or the head, or the whole body region detected by the subject detection unit 122 and information of the presence/absence of an accessory such as a mask or sunglasses determined by the state determination unit 123, the determination processing may be determined based on, for example, the size of the region of the face obtained from the region of the face or the whole body region or whether the subject wears a mask. Alternatively, the determination processing may be performed by using these determination methods in combination.

### <Determination of Fluctuation in Skin Region>

The fluctuation determination processing of the skin region in step S208 of FIG. 2 will be described next with reference to FIG. 4.

In step S401, the fluctuation determination unit 126 performs scene determination based on the subject state determined in step S205 and/or the image luminance value obtained in step S203. The scene determination processing is processing of determining whether a scene needs to undergo fluctuation determination of the skin region.

For example, in a case of a scene in which the face of the subject has shading, when the skin average luminance SkinY obtained in step S209 largely changes due to a fluctuation in the skin region, exposure varies, thereby obtaining a scene in which exposure of the skin region is unstable. This scene is determined as a scene for which it is necessary to determine a fluctuation in the skin region, and the process advances to step S402.

In a case of a scene in which the face of the subject has no shading, since variations in the skin average luminance SkinY and exposure are difficult to occur due to a fluctuation in the skin region, this scene is determined as a scene for which it is unnecessary to determine a fluctuation in the skin region, and the process advances to step S406.

Even if the state of the subject changes or the image luminance value largely changes, since priority is given to follow exposure rather than the fluctuation in the skin region, the scene is determined as a scene for which it is unnecessary to determine a fluctuation in the skin region and the process advances to step S406.

Examples of a case where the state of the subject changes are a case where the direction of the face changes from the front direction to the sideways direction, and a case where the size of the face abruptly changes from a large face to a small face. Furthermore, an example of a case where the image luminance value largely changes is a case where a change in luminance of the entire screen is large, for example, a case where a bright scene abruptly changes to a dark scene.

In step S402, the fluctuation determination unit 126 determines whether among a plurality of frames obtained in time series, the number of frames in which the face region and the skin region can be detected is equal to or larger than a predetermined number. The predetermined number is set to a number equal to or larger than the number of frames required to decide a reference skin region in step S403. If it is determined that the number of frames in which the face region and the skin region can be detected is equal to or larger than the predetermined number, the process advances to step S403. If it is determined that the number of frames in which the face region and the skin region can be detected is smaller than the predetermined number, it is impossible to obtain a reference skin region, and it is thus determined that no fluctuation occurs in the skin region, thereby ending the processing.

In step S403, the fluctuation determination unit 126 decides a reference skin region based on the detection results of the face region and the skin region.

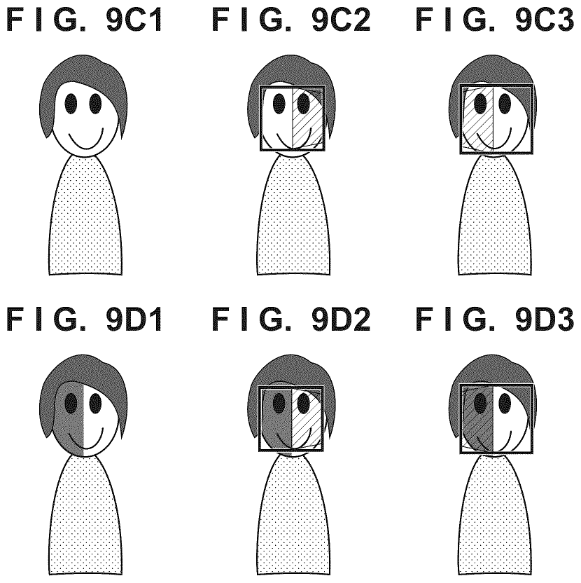

The processing of deciding the reference skin region in step S403 of FIG. 4 will now be described with reference to FIG. 10.

The reference skin region is used as a reference region to be compared with the skin region when the fluctuation determination unit 126 determines whether a fluctuation occurs in the skin region.

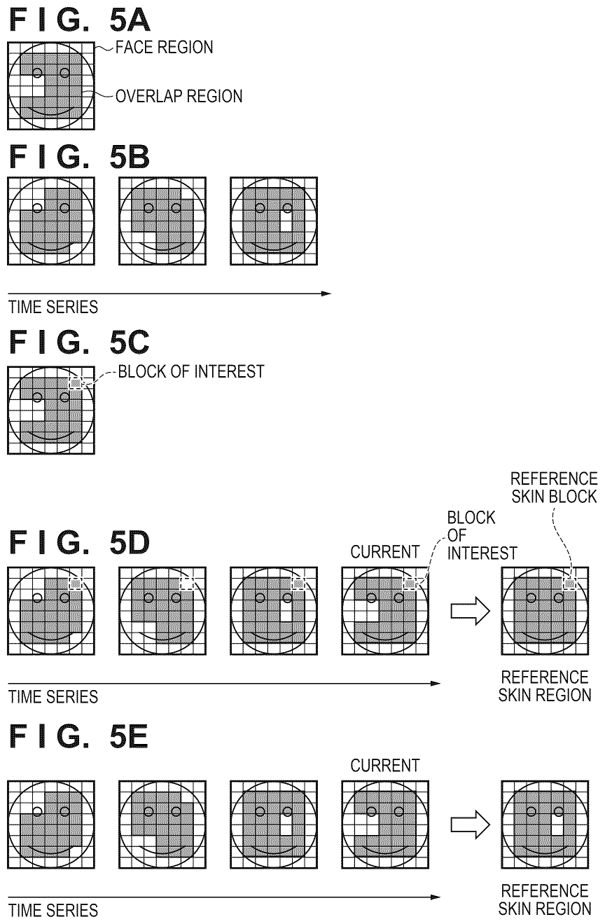

In step S1001, the fluctuation determination unit 126 obtains a region where the face region detected in step S204 and the skin region detected in step S206 overlap each other. A method of obtaining the overlap region of the face region and the skin region is as described in step S208. FIG. 5A exemplifies the overlap region of the current frame.

In step S1002, the fluctuation determination unit 126 obtains, from the memory unit 102, the face region and the skin region of each of the plurality of latest frames in which the overlap region can be obtained, thereby obtaining the overlap regions of past frames. The overlap regions of the past frames, the number of which is equal to the above-described predetermined number, are obtained. A method of obtaining the overlap region of the face region and the skin region is as described in step S209. FIG. 5B exemplifies the overlap regions of the latest three frames except for the current frame.

In step S1003, the fluctuation determination unit 126 decides whether each block in the face region is a reference skin block forming the reference skin region, and starts processing of deciding the reference skin region.

In step S1004, the fluctuation determination unit 126 decides a block of interest in the face region. In an example shown in FIG. 5C, an upper right block of the face is set as a block of interest.

In step S1005, the fluctuation determination unit 126 obtains a block at a position identical to that of the block of interest in each of the plurality of latest frames including the current frame, and determines whether the obtained block is a block determined as the overlap region. In an example shown in FIG. 5D, the block is detected as the overlap region in three frames among the latest four frames including the current frame.

In step S1006, the fluctuation determination unit 126 determines, based on a predetermined threshold, whether the block of interest is the reference skin block. The fluctuation determination unit 126 obtains the number of blocks determined as the overlap region among the blocks of the plurality of latest frames including the current frame, and compares it with the threshold. If the number of blocks determined as the overlap region is equal to or larger than the threshold, the fluctuation determination unit 126 determines that the block forms the reference skin region, and if the number of blocks is smaller than the threshold, the fluctuation determination unit 126 determines that the block does not form the reference skin region.

FIG. 5D shows an example in which a block detected as the overlap region a predetermined number (three) of times or more in the latest four frames is set as a reference skin block. By focusing on the latest four frames, a block is detected as the overlap region in three frames among the four frames. In a case where the threshold is set to three, the corresponding block can be decided as the reference skin region.

In step S1007, the fluctuation determination unit 126 stores the determination result of the reference skin region in step S1006 in the memory unit 102.

The processes of steps S1004 to S1007 are repeatedly performed for each block in the face region.

In step S1008, the fluctuation determination unit 126 decides whether each of all the blocks in the face region is a reference skin block forming the reference skin region, thereby deciding the reference skin region.

Note that the skin region of a frame in which an overlap region having a size equal to or larger than a threshold, for example, an overlap region having a largest size is obtained, among the plurality of frames in each of which the face region and the skin region are detected, may be decided as the reference skin region.

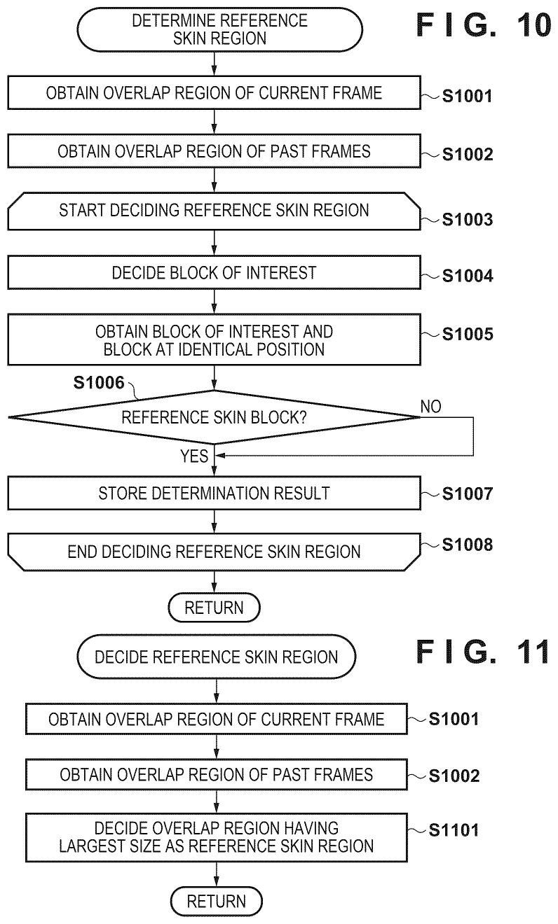

FIG. 11 is a flowchart exemplifying processing of deciding, as a reference skin region, the skin region of a frame in which an overlap region having a largest size is obtained.

Steps S1001 and S1002 are as described with reference to FIG. 10.

In step S1101, the fluctuation determination unit 126 obtains, among the plurality of latest frames including the current frame, a frame in which an overlap region having a largest size is obtained, and the overlap region.

In an example shown in FIG. 5E, in the latest four frames including the current frame, an overlap region having a largest size can be obtained in a frame immediately preceding the current frame, and thus the overlap region having the largest size is decided as a reference skin region.

In step S404, the fluctuation determination unit 126 compares the reference skin region decided in step S403 with the skin region of the current frame, thereby obtaining the degree of matching.

The degree of matching is calculated as a rate of a region, where the reference skin region and the skin region of the current frame overlap each other, to the reference skin region. For example, when NumStd represents the number of blocks of the reference skin region, and NumCurt represents the number of blocks of the skin region of the current frame, a degree Rate of matching can be given by Rate=NumCurt/NumStd.

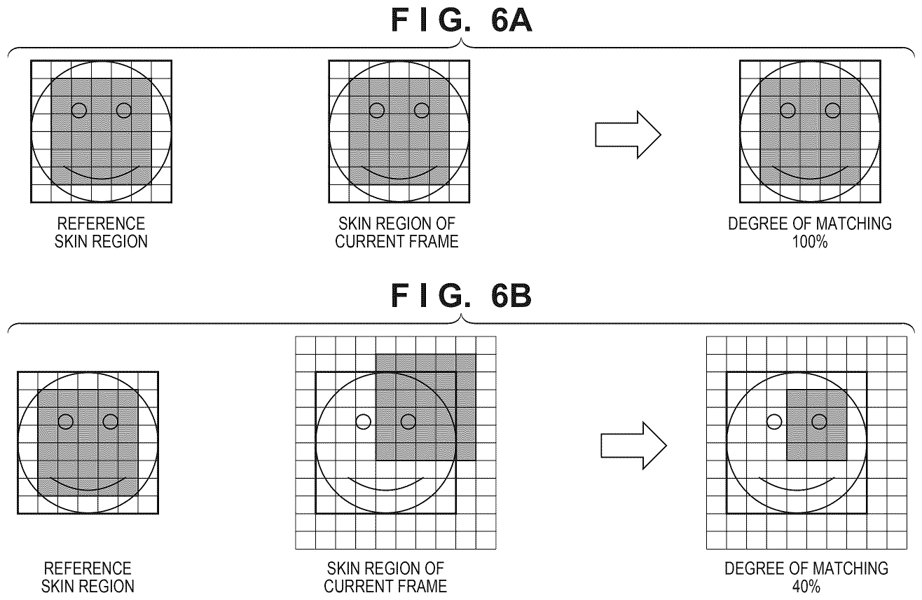

In an example shown in FIG. 6A, since the reference skin region and the skin region of the current frame completely match each other, the degree of matching is 100%. To the contrary, in an example shown in FIG. 6B, the reference skin region and the skin region of the current frame do not match each other. While the reference skin region includes 30 blocks, the overlap region includes 12 blocks, and thus the degree of matching is 40%.

In step S405, the fluctuation determination unit 126 determines, based on the degree of matching calculated in step S404, whether a fluctuation occurs in the skin region. The fluctuation determination unit 126 compares the degree of matching with a predetermined threshold. If the degree of matching is equal to or higher than the threshold, the fluctuation determination unit 126 determines that no fluctuation occurs in the skin region, and ends the processing. If the degree of matching is lower than the threshold, the fluctuation determination unit 126 determines that a fluctuation occurs in the skin region, and ends the processing.

For example, if the threshold is set to 50%, in the example shown in FIG. 6A, the degree of matching that is 100% exceeds the threshold, and it is thus determined that no fluctuation occurs in the skin region. On the other hand, in the example shown in FIG. 6B, since the degree of matching that is 40% is lower than the threshold, it is determined that a fluctuation occurs in the skin region.

In step S406, the fluctuation determination unit 126 initializes the reference skin region. The initialization processing of the reference skin region is performed when it is determined in step S401 that it is unnecessary to perform the fluctuation determination processing of the skin region, for example, when a scene in which a fluctuation is difficult to occur in the skin region is determined or when the subject state or the image luminance value changes. In this case, when the reference skin region before the change of the scene is compared to the skin region of the current frame after the change of the scene, it is impossible to correctly determine a fluctuation in the skin region, and thus the reference skin region is initialized.

As described above, according to the present embodiment, it is determined whether a fluctuation occurs in a skin region, and if a fluctuation occurs in the skin region, exposure is controlled based on a photometric value obtained when no fluctuation occurs in the skin region. In this way, even if a fluctuation occurs in the skin region, exposure can be stabilized. Furthermore, according to the present embodiment, by performing fluctuation determination processing of the skin region in a scene for which it is necessary to perform fluctuation determination processing of the skin region, it is possible to correctly determine a fluctuation in the skin region. By performing fluctuation determination processing of the skin region based on the degree of matching with the reference skin region obtained from a plurality of frames in each of which the face region and the skin region can be detected, it is possible to perform appropriate exposure control even in a case where, for example, the face region is small and it is difficult to detect the skin region.

According to the present disclosure, even in a case where a fluctuation occurs in a subject detection region, it is possible to stabilize exposure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-207703, filed Nov. 28, 2024 which is hereby incorporated by reference herein in its entirety.

What is claimed is:

1. An image processing apparatus comprising:
at least one processor; and
at least one memory coupled to the at least one processor storing instructions that, when executed by the at least one processor, cause the at least one processor to function as:
a first obtaining unit that obtains an image;
a first detection unit that detects a first region including a subject in the image;
a second detection unit that detects a second region in the image;
a second obtaining unit that obtains, in a case where a state of the subject is a predetermined state, a photometric result based on luminance of a region where the first region and the second region overlap each other;
a first determination unit that determines a change in the second region based on a reference region of the second region; and
a decision unit that decides exposure based on a determination result of the first determination unit and the photometric result obtained by the second obtaining unit.

2. The apparatus according to claim 1, wherein the at least one processor functions as a second determination unit that determines the state of the subject,
wherein the second determination unit determines a direction of the subject.

3. The apparatus according to claim 1, wherein the at least one processor functions as a second determination unit that determines the state of the subject,
wherein the second determination unit determines an accessory of the subject or the presence/absence of the accessory.

4. The apparatus according to claim 2, wherein the predetermined state includes a state in which the subject faces front or sideways.

5. The apparatus according to claim 1, wherein the first determination unit decides the reference region based on detection results of the first region and the second region included in each of a plurality of images obtained in time series.

6. The apparatus according to claim 5, wherein the first determination unit decides, as the reference region, a region in which a region where the first region and the second region overlap each other is detected not less than a predetermined number of times in the plurality of images.

7. The apparatus according to claim 5, wherein the first determination unit decides, as the reference region, a region having a size not smaller than a threshold, among regions detected from the plurality of images, in each of which the first region and the second region overlap each other.

8. The apparatus according to claim 5, wherein the first determination unit decides the reference region in a case where the number of the plurality of images is not less than a predetermined number.

9. The apparatus according to claim 1, wherein the first determination unit determines a change in the second region based on the degree of matching between the second region and the reference region.

10. The apparatus according to claim 9, wherein in a case where the degree of matching between the second region and the reference region is lower than a threshold, the first determination unit determines that the second region changes.

11. The apparatus according to claim 1, wherein
the first determination unit decides, based on the state of the subject and/or a luminance value of the image, whether to determine a change in the second region, and
in a case where a change in the second region is not determined, the reference region is initialized.

12. The apparatus according to claim 1, wherein the second obtaining unit calculates a photometric value from a difference between a target luminance value of the first region and the luminance value of the region where the first region and the second region overlap each other.

13. The apparatus according to claim 1, wherein the second obtaining unit calculates a photometric value from a target luminance value of the image and a difference between a luminance value of the first region and the luminance value of the region where the first region and the second region overlap each other.

14. The apparatus according to claim 12, further comprising an imaging unit that captures the image and a control unit that controls exposure at the time of capturing the image,
wherein the decision unit calculates an exposure correction value based on the photometric result, and
the control unit controls exposure at the time of capturing the image based on the exposure correction value.

15. The apparatus according to claim 14, wherein
in a case where the state of the subject is not the predetermined state, the second obtaining unit does not obtain the photometric result, and
the decision unit calculates the exposure correction value based on a photometric result obtained in previous processing.

16. The apparatus according to claim 14, wherein
in a case where it is determined that the second region changes, the second obtaining unit does not obtain the photometric result, and
the decision unit calculates the exposure correction value based on a photometric result obtained in previous processing.

17. The apparatus according to claim 1, wherein
the first region is a face region of a person, and
the second region is a skin region.

18. The apparatus according to claim 17, wherein
the change in the second region includes a state in which a luminance difference occurs in the skin region.

19. An image processing method executed by an image processing apparatus comprising:
obtaining an image;
detecting a first region including a subject in the image;
detecting a second region with a predetermined characteristic in the image;
obtaining, in a case where a state of the subject is a predetermined state, a photometric result based on luminance of a region where the first region and the second region overlap each other;
determining a change in the second region based on a reference region of the second region; and
deciding exposure based on a determination result of the change in the second region and the photometric result.

20. A non-transitory computer-readable storage medium storing a program for causing a computer to function as an image processing apparatus comprising:
a first obtaining unit that obtains an image;
a first detection unit that detects a first region including a subject in the image;
a second detection unit that detects a second region in the image;
a second obtaining unit that obtains, in a case where a state of the subject is a predetermined state, a photometric result based on luminance of a region where the first region and the second region overlap each other;
a first determination unit that determines a change in the second region based on a reference region of the second region; and
a decision unit that decides exposure based on a determination result of the first determination unit and the photometric result obtained by the second obtaining unit.
